(19) United States
(12) Patent Application Publication
(10) Pub. No.: US 2006/0247934 A1
(43) Pub. Date: Nov. 2, 2006

(54) Intellectual property management device and intellectual property management program

(76) Inventors: Junichi Umehara, Tokyo (JP); Takao Tazawa, Tokyo (JP); Yasuo Kondo, Kanagawa-ken (JP); Yasuo Katera, Tokyo (JP)

Correspondence Address: BRINKS HOFER GILSON & LIONE, P.O. BOX 10395, CHICAGO, IL, 60610, US

(21) Appl. No.: 10/539,470

(22) PCT Filed: Dec. 22, 2003
(86) PCT No.: PCT/JP03/16478

§ 371 Date: Apr. 5, 2006

(30) Foreign Application Priority Data
Dec. 26, 2002 (JP) 2002-378406

(51) Int. Cl. G06Q 99/00

(52) U.S. Cl. 705/1

(57) ABSTRACT

An intellectual property right is listed at an appropriate price by monitoring an initial price set by a broker, and circulation of the intellectual property right is promoted. A Web site references a database including a right situation of a right to be sold and evaluation data used to evaluate the right, determines the value evaluation price of the right to be sold, acquires a listing initial price to be input according to the value evaluation price determined here, and invalidates the initial price if the initial value exceeds a predetermined upper limit price. Here, the predetermined upper limit price is calculated by α×(1+γ) wherein α is a value evaluation price to be calculated and γ is a coefficient in a range of 0<γ<1.

### TECHNICAL FIELD

The present invention relates to an intellectual-property management device and an intellectual-property management program, which manage intellectual properties, such as inventions, devices, designs, and so forth.

### BACKGROUND ART

Conventionally, in the event that an application is filed for authorizing an intellectual property such as an invention, device, design, and so forth, determination is made regarding whether or not an application can be filed by evaluating the intellectual property. For example, the economic value of an intellectual property according to a commercial product has been calculated in accordance with contribution to economic effects based on the functions and performance of the entire commercial product to be evaluated (see Japanese Unexamined Patent Application Publication No. 2002-197265, for example). An intellectual-property manager, for example, has determined regarding whether or not an application can be filed based on this calculated economic value.

However, since the various events of procedures such as a request for application examination, response as to the reasons for rejection, registration, objection, individual trial, maintenance of rights (payment of patent fees, etc.), and the like occur as well as an application in order to authorize and maintain the right of an intellectual property, it has been a considerable burden for the intellectual-property manager to determine how to evaluate the economic value of the intellectual property for each event, and how to handle the event. In light of such a situation, it has been demanded to improve workability of determining processing suitable for the events of procedures according to an intellectual property.

The present invention has been made in light of such a situation, and the object thereof is to provide an intellectual-property management device capable of managing intellectual properties based on the economic value of each intellectual property of which the application is scheduled to be filed or has been filed.

Also, it is another object for the present invention to provide an intellectual-property management program for realizing the intellectual-property management device thereof using a computer.

### DISCLOSURE OF INVENTION

In order to solve the above problems, an intellectual-property management device according to the present invention is an intellectual-property management device for managing an intellectual property of which the application is scheduled to be filed or has been filed, the management device comprising: an intellectual-property data storage unit for storing management data regarding the intellectual property for each intellectual property; an evaluation parameter storage unit for storing evaluation parameter data for each intellectual property; a cost-calculation data storage unit for storing predetermined cost data to be used for calculating costs necessary for authorizing and maintaining the right of said intellectual property; event input means for inputting the event information of procedures according to an intellectual property right; evaluation parameter input means for inputting evaluation parameter data of the intellectual property; evaluation calculation unit for calculating the evaluation of the intellectual property based on the management data and the evaluation parameter data; an authorization-fee calculation unit for calculating an authorization fee necessary in the future for authorizing and maintaining the right of the intellectual property based on the management data and the cost data; and a management unit for, in response to the event information input, comparing the calculated evaluation with the authorization fee when the event occurs, and managing the intellectual property based on this compared result.

According to this invention, intellectual properties can be managed based on the economic value of each intellectual property of which the application is scheduled to be filed or has been filed.

Also, the authorization-fee calculation unit preferably calculates a total fee necessary in the future for authorizing and maintaining the right of the intellectual property.

Also, the intellectual-property management device according to the present invention further comprises an implementing-fee calculation unit for calculating an implementing-fee necessary (research and development costs, for example) in the future for implementing the intellectual property, and the management unit adds the implementing-fee to the authorization fee, compares the result with the evaluation, and manages the intellectual property based on this compared result.

According to this invention, the cost effectiveness of research and development can be quickly accurately grasped.

Also, the intellectual-property management device according to the present invention further comprises a refund calculation unit for calculating a refund as to the inventor of the intellectual property based on the evaluation.

According to this invention, an amount identical to the value of the intellectual property can be returned to an inventor in lump sum.

Also, the intellectual-property management device according to the present invention further comprises an asset-capitalization-amount calculation unit for targeting at the intellectual property of which the evaluation is a predetermined amount or more for asset capitalization, and calculating the total amount of the evaluation of the intellectual property to be capitalized.

According to this invention, intellectual property accounting can be handled.

Also, the asset-capitalization-amount calculation unit includes a function for determining whether or not the intellectual property is authorized based on the management data, and restricts the intellectual property to be capitalized to an authorized intellectual property.

Also, the intellectual-property management device according to the present invention, the management unit determines whether or not procedures according to an intellectual property are necessary based on the compared result.

According to this invention, determination is made objectively regarding whether or not procedures according to an intellectual property are necessary based on the economic value of the intellectual property, thereby improving workability of determining processing suitable for the event of procedures according to the intellectual property.

Also, with the intellectual-property management device according to the present invention, the evaluation calculation unit for determining that a shorter duration of either the technical remaining life or the right duration of the intellectual property is taken as the service life of the intellectual property, and depreciating the evaluation of the intellectual property in accordance with a predetermined depreciation rule (for example, the equal installment method, constant percentage method, etc.) based on the service life of the authorized intellectual property, and the management unit outputs a message prompting stopping of payment of expenses necessary for maintaining the right of the intellectual property in the event that the evaluation of the intellectual property depreciated is less than the right-authorizing costs.

According to this invention, cost effectiveness of maintaining rights, such as pensions and so forth, can be realized.

Also, with the intellectual-property management device according to the present invention, the management unit determines whether or not the application of the intellectual property is necessary based on the evaluation of the intellectual property when the succession or application of the intellectual property is filed.

According to this invention, an application can be filed effectively based on the economic value of an intellectual property.

Also, with the intellectual-property management device according to the present invention, the management unit determines the type of application based on the evaluation of the intellectual property when the succession or application of the intellectual property is filed.

According to this invention, an application of a suitable type based on the economic value of an intellectual property can be filed.

Also, with the intellectual-property management device according to the present invention, the evaluation parameter data includes parameter data regarding possibility of right-to-implementation for each claim of the intellectual property, and the management unit sets the evaluation of the intellectual property to zero in the event that all of the claims having possibility of right-to-implementation are deleted by amendment of the right generic claim of the intellectual property using the event information.

According to this invention, change in the economic value of an intellectual property based on amendment is reflected accurately on the evaluation of the intellectual property.

Also, with the intellectual-property management device according to the present invention, the management unit outputs a message prompting reevaluation of the evaluation items regarding the claims to be amended in the event that the claims having possibility of right-to-implementation of the right generic claim of the intellectual property are amended using the event information.

According to this invention, the economic value of an intellectual property changing due to amendment is appropriately evaluated, and is reflected on the evaluation of the intellectual property.

The intellectual-property management device according to the present invention is an intellectual-property management device for managing an intellectual property of which the application is scheduled to be filed or has been filed, calculating evaluation of said intellectual property from the time the intellectual property was registered, and capitalizing this evaluation as fixed assets.

An intellectual-property management program according to the present invention is an intellectual-property management program for performing intellectual property management processing in an intellectual-property management device for managing an intellectual property of which the application is scheduled to be filed or has been filed, the program for controlling a computer to execute: processing for inputting the event information of procedures according to an intellectual property; processing for inputting the evaluation parameter data of the intellectual property; evaluation calculation processing for calculating the evaluation of the intellectual property based on the management data and the evaluation parameter data regarding the intellectual property, which is stored in the storage unit; authorization-fee calculation processing for calculating an authorization fee necessary in the future for authorizing and maintaining the right of the intellectual property based on the management data and predetermined cost data, which is stored in a storage unit, to be used for calculating costs necessary for authorizing and maintaining the right of the intellectual property; and management processing for, in response to the event information input, comparing the calculated evaluation with the authorization fee when the event occurs, and managing the intellectual property based on this compared result.

Also, with the intellectual-property management program according to the present invention, the authorization-fee calculation processing calculates a total fee necessary in the future for authorizing and maintaining the right of the intellectual property.

Also, the intellectual-property management program according to the present invention further controls the computer to execute implementing-fee calculation processing for calculating an implementing-fee necessary in the future for implementing the intellectual property, and the management processing adds the implementing-fee to the authorization fee, compares the result with the evaluation, and manages the intellectual property based on this compared result.

Also, the intellectual-property management program according to the present invention further controls the computer to execute refund calculation processing for calculating a refund as to the inventor of the intellectual property based on the evaluation.

Also, the intellectual-property management program according to the present invention further controls the computer to execute asset-capitalization-amount calculation processing for targeting at the intellectual property of which the evaluation is a predetermined amount or more for asset capitalization, and calculate the total amount of the evaluation of the intellectual property to be capitalized.

Also, with the intellectual-property management program according to the present invention, the asset-capitalization-amount calculation processing for determining whether or not the intellectual property is authorized based on the management data, and restricts the intellectual property to be capitalized to an authorized intellectual property.

Also, with the intellectual-property management program according to the present invention, the management processing determines whether or not procedures according to an intellectual property right are necessary based on the compared result.

Also, with the intellectual-property management program according to the present invention, the evaluation calculation processing for determining that a shorter duration of either the technical remaining life or the right duration of the intellectual property is taken as the service life of the intellectual property, and depreciating the evaluation of the intellectual property in accordance with a predetermined depreciation rule based on the service life of the authorized intellectual property, and the management processing outputs a message prompting stopping of payment of expenses necessary for maintaining the right of the intellectual property in the event that the evaluation of the intellectual property depreciated is less than the right-authorizing costs.

Also, with the intellectual-property management program according to the present invention, the management processing determines whether or not the application of the intellectual property is necessary based on the evaluation of the intellectual property when the succession or application of the intellectual property is filed.

Also, with the intellectual-property management program according to the present invention, the management processing determines the type of application based on the evaluation of the intellectual property when the succession or application of the intellectual property is filed.

Also, with the intellectual-property management program according to the present invention, the evaluation parameter data includes parameter data regarding possibility of right-to-implementation for each claim of the intellectual property, and the management processing sets the evaluation of the intellectual property to zero in the event that all of the claims having possibility of right-to-implementation are deleted by amendment of the right generic claim of the intellectual property using the event information.

Also, with the intellectual-property management program according to the present invention, the management processing outputs data prompting reevaluation of the evaluation items regarding the claims to be amended in the event that the claims having possibility of right-to-implementation of the right generic claim of the intellectual property are amended using the event information.

The intellectual-property management program according to the present invention is an intellectual-property management program for performing intellectual-property management processing in an intellectual-property management device for managing an intellectual property of which the application is scheduled to be filed or has been filed, the program for controlling a computer to execute: processing for calculating the evaluation of the intellectual property from the time the intellectual property was registered; and processing for capitalizing this evaluation as fixed assets.

According to the above intellectual-property management program, the above intellectual-property management device can be realized using a computer.

### BRIEF DESCRIPTION OF THE DRAWINGS

FIG. 1 is a block diagram illustrating the configuration of an intellectual-property management device according to an embodiment of the present invention.

FIG. 2A and FIG. 2B are diagrams illustrating a configuration example of intellectual property data stored in an intellectual-property data storage unit 21.

FIG. 3A and FIG. 3B are diagrams illustrating a configuration example of a conversion table regarding a capital strength J and operating strength K.

FIG. 4A and FIG. 4B are diagrams illustrating a configuration example of evaluation parameter data to be stored in an evaluation parameter data storage unit 22.

FIG. 5 is a diagram illustrating an example of the evaluation items of intellectual property and the evaluation basis thereof.

FIG. 6 is a first flowchart illustrating the flow of intellectual management processing performed by the intellectual-property management device illustrated in FIG. 1.

FIG. 7 is a second flowchart illustrating the flow of intellectual management processing performed by the intellectual-property management device illustrated in FIG. 1.

FIG. 8 is a first flowchart illustrating the flow of authorization-fee calculation processing performed by an authorization-fee calculation unit 12.

FIG. 9 is a second flowchart illustrating the flow of authorization fee calculation processing performed by the authorization-fee calculation unit 12.

FIG. 10 is a third flowchart illustrating the flow of authorization-fee calculation processing performed by the authorization-fee calculation unit 12.

FIG. 11A through FIG. 11D are diagrams illustrating a configuration example of cost calculation data to be stored in a cost calculation data storage unit 23.

FIG. 12 is a block diagram illustrating the configuration of the intellectual-property management device in the case of providing an implementing-fee calculation unit 15 in a processing unit 1 with an embodiment of the present invention.

FIG. 13 is a block diagram illustrating the configuration of the intellectual-property management device in the case of providing a refund calculation unit 16 in the processing unit 1 with an embodiment of the present invention.

### BEST MODE FOR CARRYING OUT THE INVENTION

Description will be made below regarding an embodiment of the present invention with reference to the drawings. Note that with the present embodiment, an invention and the patent right thereof, a device and the utility model thereof, and a design and the design right thereof will be principally described as examples of intellectual properties and the rights thereof.

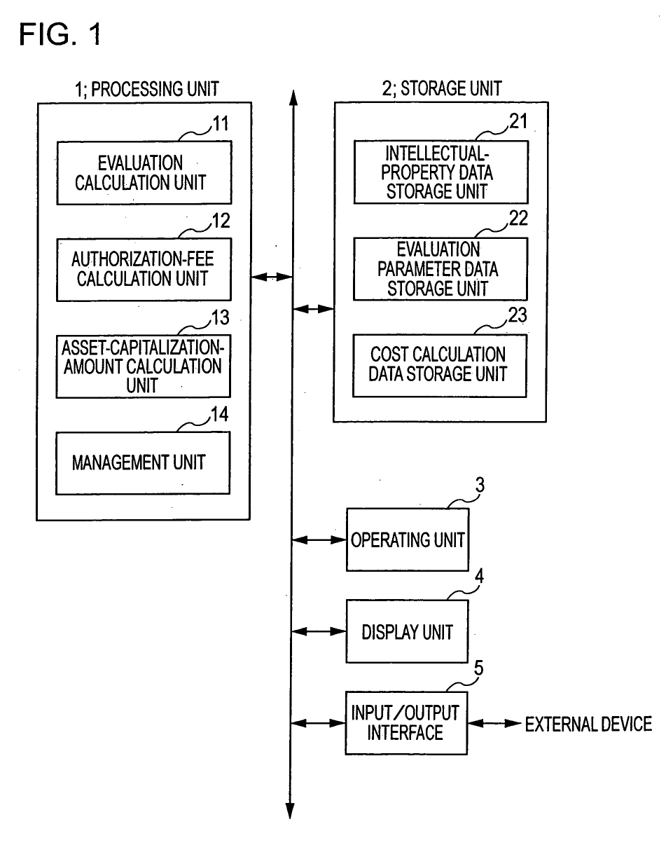

FIG. 1 is a block diagram illustrating the configuration of an intellectual-property management device according to an embodiment of the present invention. In FIG. 1, the intellectual-property management device comprises a processing unit 1, storage unit 2, operating unit 3, display unit 4, and input/output interface 5. The respective units 1 through 5 are connected to a bus. The processing unit 1 includes an evaluation calculation unit 11, authorization-fee calculation unit 12, asset-capitalization-amount calculation unit 13, and management unit 14.

The evaluation calculation unit 11 calculates the evaluations of intellectual properties. The authorization-fee calculation unit 12 calculates fees such as an application filing fee and the like necessary in the future for authorizing an intellectual property, and fees such as a patent fee and the like necessary in the future for maintaining the right of the intellectual property (these fees are referred to as an authorization fee). The asset-capitalization-amount calculation unit 13 calculates the total amount of the evaluations of intellectual properties to be capitalized. The management unit 14 manages intellectual properties based on the evaluations and authorization fees thereof and so forth.

The storage unit 2 is for storing various types of data to be used for evaluation and management of intellectual properties, and includes a storage unit 21 of intellectual property data serving as management data regarding intellectual properties, storage unit 22 of evaluation parameter data, and storage unit 23 of cost calculation data.

The operating unit 3 comprises a keyboard for an operator inputting data, and an input device such as a mouse or the like. The display unit 4 comprises a display device (CRT (Cathode Ray Tube) for displaying data, liquid crystal display device, or the like). The input/output interface 5, which is connected to an external device such as a printing device, recording medium (flexible disk, etc.) read/write device, or the like, performs input/output of data. Also, the input/output interface 5 may include a communication function, which performs transmission/reception of data by connecting to an external computer via a communication line.

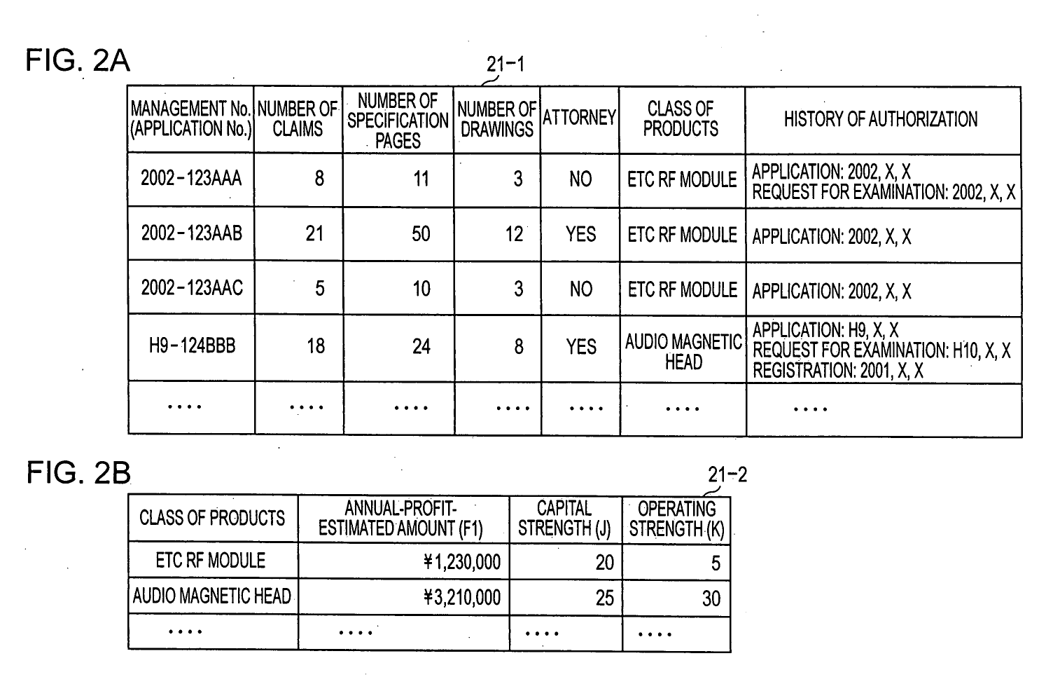

FIG. 2A and FIG. 2B are diagrams illustrating a configuration example of intellectual property data stored in an intellectual-property data storage unit 21, wherein FIG. 2A illustrates data 21-1 for identifying intellectual properties, and FIG. 2B illustrates data 21-2 relating to products each of which an intellectual property is applied to. The data 21-1 includes each data of a unique management number, the number of claims, the number of specification pages, the number of drawings, involvement/noninvolvement of an attorney, class of products, which is applied to each intellectual property, and history of authorization, for each intellectual property. An application number is employed for an intellectual property of which the application has been filed as a management number. History information of authorization includes the date when each procedure has been implemented, the procedure content thereof (application, request for examination, registration, payment of a patent fee, the number of paid years thereof).

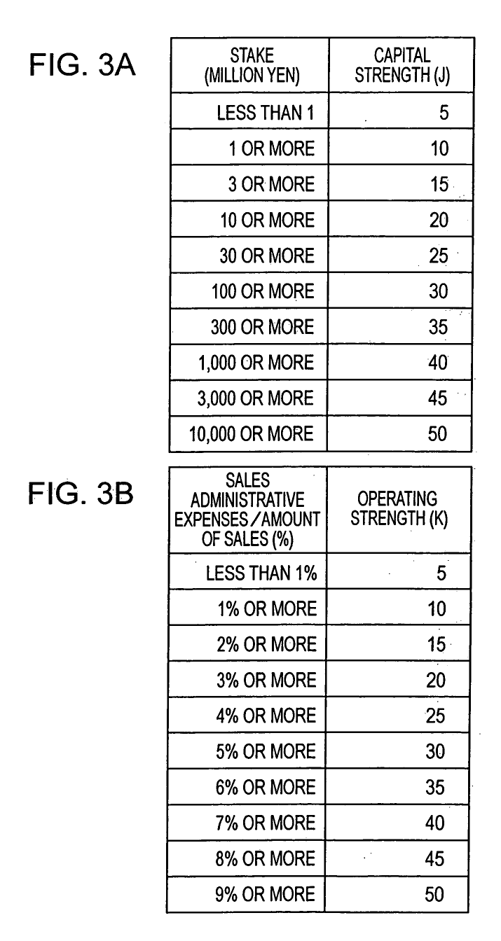

The data 21-2 includes each data of annual-profit-estimated amount (F1), capital strength (J), and operating strength (K), for each class of products. The operating strength (J) is obtained by the amount of capital investment relating to the relevant product being parameterized based on the conversion table illustrated in FIG. 3A. The operating strength K is obtained by the proportion of sales administrative expense occupied in the amount of sales of the relevant product being parameterized based on the conversion table illustrated in FIG. 3B.

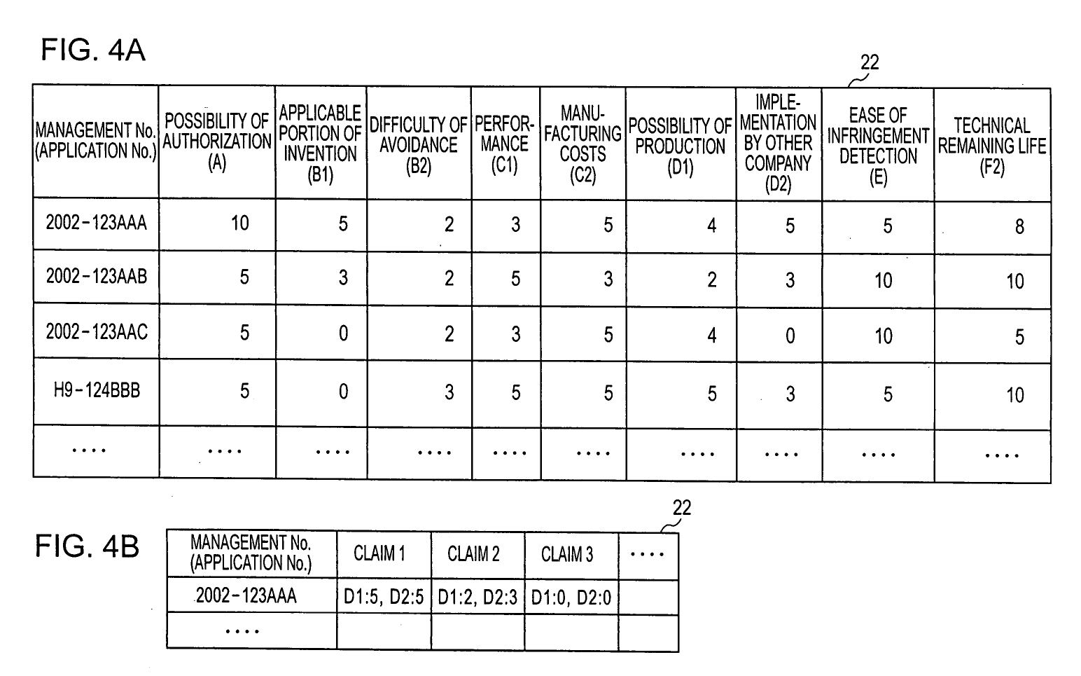

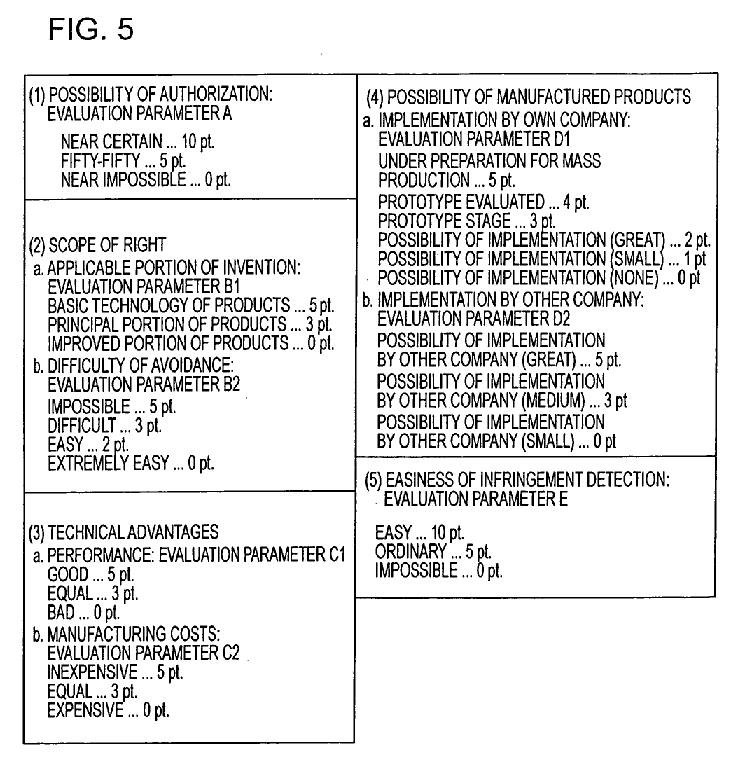

FIG. 4A and FIG. 4B are diagrams illustrating a configuration example of evaluation parameter data to be stored in the evaluation parameter data storage unit 22. The evaluation parameter data includes a unique management number, and each data of various types of evaluation parameters A, B1, B2, C1, C2, D1, D2, E, and F2 for each intellectual property, as illustrated in FIG. 4A. Further, as illustrated in FIG. 4B, the evaluation parameter data includes each data of evaluation parameters D1 and D2 for each claim in the scope of each intellectual property right. The evaluation parameters A, B1, B2, C1, C2, D1, D2, and E are obtained by the value of the relevant intellectual property being parameterized based on the evaluation reference regarding each evaluation item illustrated in FIG. 5, wherein values input are stored.

The evaluation parameter A represents a level regarding possibility of authorization. The evaluation parameters B1 and B2 represent levels regarding the scope of a right, wherein the evaluation parameter B1 represents a level according to the applicable portion of an invention, and the evaluation parameter B2 represents a level according to the difficulty of avoidance. The evaluation parameters C1 and C2 represent levels regarding technical advantages, wherein the evaluation parameter C1 represents a level according to performance, and the evaluation parameter C2 represents a level according to manufacturing costs. The evaluation parameters D1 and D2 represent levels regarding possibility of manufactured products, wherein the evaluation parameter D1 represents a level according to possibility of right-to-implementation by the own company, and the evaluation parameter D2 represents a level according to possibility of right-to-implementation by other company. The evaluation parameter E represents a level according to easiness of infringement detection.

The technical remaining life F2 means an estimated life duration in the technical life cycle or design life cycle of the relevant intellectual property. This duration is represented in the term of years. In the case in which this duration is less than a year, i.e., several months, a ratio of the number of months/12 months is employed. In the case in which the ability of right-to-implementation of the relevant estimated license holder is less than the estimated life duration, the ability of right-to-implementation by the estimated license holder is employed as the technical remaining life F2. In this case, handling of years and months as duration is as the same as the above. With regard to the technical remaining life F2, the initial value thereof is input for each intellectual property, and hereinafter, the management unit 14 decrements the value thereof by one year every year.

The cost calculation data stored in the cost calculation data storage unit 23 includes various types of data used for calculation of an authorization fee.

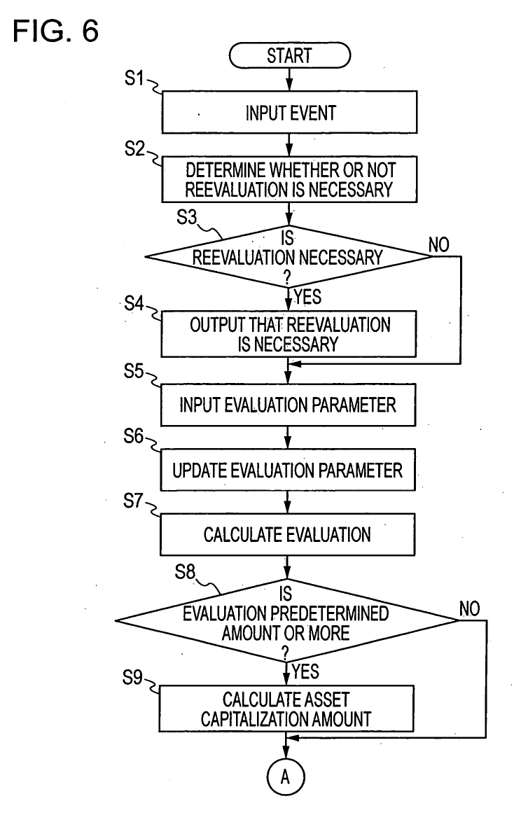

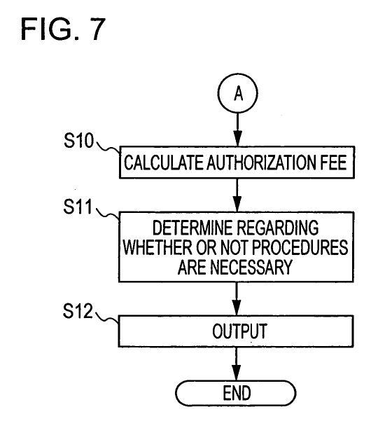

Next, description will be made regarding operation of the intellectual-property management device illustrated in FIG. 1 with reference to FIG. 6 and FIG. 7. FIG. 6 and FIG. 7 are flowcharts illustrating the flow of the intellectual management processing performed by the intellectual-property management device. The following description will be made principally regarding an invention and the patent right thereof as an example.

First, an operator inputs the event information of procedures according to an intellectual property right using the operating unit 3 (Step S1 in FIG. 6). The event information input here includes the type of an event, and the management number of an intellectual property and intellectual property information according to the event. Examples of the types of an event include succession of an intellectual property, application, request for examination, intermediate processing handling (response to the reasons for rejection, and the like), registration, objection, individual trial, and maintenance of a right (payment of a patent fee etc.). Examples of the intellectual property information include claims to be amended in the event of amending the scope of an intellectual property right, the type of amendment thereof (addition/modification/deletion), the number of pages of a specification of which the application is filed, the number of drawings, involvement/noninvolvement of an attorney, class of products to be applied and the capital strength J and operating strength K thereof, and history information of authorization. The operator should input, for example, update information alone regarding the intellectual property information as necessary. The management unit 14 updates the intellectual property data of the intellectual-property data storage unit 21 using the intellectual property information input here.

Note that input of the type and management number of an event may be performed from an external computer via a communication line. For example, an arrangement may be made wherein the intellectual-property management device is connected to a server managing the events of procedures according to an intellectual property right, and the server inputs the type of an event and the relevant management number prior to a certain period of the procedure limit (prior to 30 days, for example). Further, an arrangement may be made wherein the management unit 14 displays or prints out the effect that the event occurs in response to the input, and prompts the operator to input necessary intellectual property information.

Next, the management unit 14 determines whether or not reevaluation for the value of the relevant intellectual property is necessary based on the event information input (Step S2). Here, the management unit 14 determines whether or not claims having possibility of right-to-implementation are amended based on the intellectual property information input and the possibility of right-to-implementation for each claim of the relevant intellectual property (the evaluation parameter data in FIG. 4B) at the time of amendment (Step S3). As a result of this determination, in the event that the claims having possibility of right-to-implementation are amended, a message prompting the operator to perform reevaluation for the relevant claims to be amended is displayed using the display unit 4. Or, this message is printed out (Step S4). The evaluation parameters to be reevaluated at the time of amendment are all of the evaluation parameters A, B1, B2, C1, C2, D1, D2, and E other than the technical remaining life F2.

Also, display prompting the operator to perform reevaluation for the evaluation parameters D1 and D2 (possibility of manufactured products) and the technical remaining life F2 is performed using the display unit 4 at the time of requesting for examination and maintaining a right.

Thus, the value of the relevant intellectual property is reevaluated.

Next, the operator inputs an evaluation parameter using the operating unit 3 (Step S5). The information input here includes each evaluation item parameter obtained by the value of the relevant intellectual property being parameterized based on the evaluation reference in FIG. 5, and the technical remaining life F2. The operator should input only the initial values or the parameters to be updated. For example, all of the parameters are input at the time of succession of an intellectual property of which the application is scheduled to be filed, but only the parameters to be modified should be input when the subsequent event occurs. The management unit 14 updates the evaluation parameter data in the evaluation parameter data storage unit 22 of the relevant intellectual property using the evaluation parameters input (Step S6). Here, when registration is performed, the management unit 14 sets the evaluation parameter A (possibility of authorization) to “10” (authorized).

Next, the evaluation calculation unit 11 calculates the evaluation of the intellectual property corresponding to the management number of the event information input (Step S7). Here, the evaluation calculation unit 11 calculates the current value of profits of a product (F0) belonged in the class of products to which the relevant intellectual property is applied using the following Expression (1).

CURRENT VALUE OF PROFITS OF PRODUCT

$$( F 0 ) = {\sum }_{n = 1}^{F 2} \frac{F 1}{{( 1 + F 3 )}^{n}} \qquad ( 1 )$$

Here, F1 represents an annual profit estimated amount (yen), F2 represents a technical remaining life (years), and F3 represents a discount rate.

The annual profit estimated amount F1 is calculated as the cash flow of the relevant year using the following expression.
SALES−COST OF SALES−SALES ADMINISTRATIVE EXPENSES±BUSINESS RELATED PROFIT AND LOSS (SUB TOTAL) BUSINESS PROFIT−ACTUAL TAX (TAX RATE: ASSUMED AS 40%) (SUB TOTAL) BUSINESS PROFIT AFTER ACTUAL TAX+NON-CASH EXPENSE (DEPRECIATION EXPENSE, ETC.)−DEDUCTIBLE ITEMS (INCREASING WORKING CAPITAL, BUSINESS INVESTMENT, ETC.) (SUM TOTAL) PROFIT ESTIMATED AMOUNT OF RELEVANT YEAR (PROFITS)

Note that with the above expression, the actual tax rate is that in Japan, and with a foreign country, calculation would be performed using the actual tax rate in the relevant foreign country.

The term “discount rate” is an index for discounting the future profits into the current value, which is a value determined for each enterprise. The above annual profit estimated amount F1 is merely a predicted value, so it is necessary to get the value back to the current value. A coefficient used for this is referred to as a “discount rate”. This “discount rate” is calculated using the following expression. When a discount rate cannot be calculated based on this expression, or it is difficult to calculate a discount rate based on this expression, a predetermined value, for example, a value in a range between 5 and 10% may be employed.
DISCOUNT RATE (F3)=WACC (Weighted Average Cost of Capital)+INFLATION RATE+RISK PREMIUM

WACC is calculated using the following expression.
WACC=STOCKHOLDER'S EQUITY COSTS×STOCKHOLDER'S EQUITY RATE+DEBT COSTS AFTER TAX×DEBT RATE

Here, STOCKHOLDER'S EQUITY RATE is obtained by STOCKHOLDER'S EQUITY TOTAL AMOUNT/(TOTAL DEBTS+STOCKHOLDER'S EQUITY TOTAL AMOUNT), and DEBT RATE is obtained by TOTAL DEBTS/(TOTAL DEBTS+STOCKHOLDER'S EQUITY TOTAL AMOUNT).

Also, WACC may be calculated with the following expression.
WACC=Ke×PE+Kd×PD

Here,

Ke: CAPITAL ADEQUACY COSTS=Rf+a (Rm−Rf)

Rf: EARNING RATE OF RISK-FREE SECURITY (LONG-TERM GOVERNMENT BOND (10-YEAR), FOR EXAMPLE)

a: SYSTEMATIC RISK

Rm: EARNING RATE OF COMMON MARKET

Kd: BORROWED MONEY COSTS AFTER TAX

PE: CAPITAL ADEQUACY RATIO (EQUITY CAPITAL/TOTAL CAPITAL) . . . MARKET BASIS

PD: BORROWED MONEY RATIO (BORROWED MONEY/TOTAL CAPITAL) . . . MARKET BASIS

Note that each data used for calculation of the above annual profit estimated amount F1 and discount rate F3 is input by the operator. Alternately, an arrangement may be made wherein information serving as a basis for calculating the cash flow of an enterprise is acquired by accessing an enterprise information data base via a communication line.

Next, the evaluation calculation unit 11 calculates the contribution rate (L) of the relevant intellectual property using the following Expression (2).

$$SPECIFIC CONTRIBUTION RATE OF INTELLECTUAL PROPERTY ( L ) = MEAN OF INVENTIVE FACULTY / ( MEAN OF INVENTIVE FACULTY + CAPITAL STRENGTH + OPERATING STRENGTH ) \times SPECIFIC INVENTIVE FACULTY / SUM OF INVENTIVE FACULTY = \frac{\sum I / H}{\sum I / H + J + K} \times \frac{I}{\sum I} \qquad ( 2 )$$

Here, I represents the inventive faculty of a specific (relevant) intellectual property, and is defined as the sum of the evaluation parameters A, B1, B2, C1, C2, D1, D2, and E of the relevant intellectual property as shown in the following expression, and is calculated.
SPECIFIC INVENTIVE FACULTY OF INTELLECTUAL PROPERTY (I)=A+B1+B2+C1+C2+D1+D2+E

ΣI is the sum of the inventive faculties of the intellectual properties relating to the product of the class of products to which the relevant intellectual property is applied. H is the number of intellectual properties relating to the product of the class of products. ΣI/H is the mean of the inventive faculties of the intellectual properties relating to the product of the class of products.

Next, the evaluation calculation unit 11 calculates the current value of the relevant intellectual property (M) with the following expression using the current value of product profits (F0) calculated using the above Expressions (1) and (2), and the contribution rate of a specific intellectual property (L).
CURRENT VALUE OF INTELLECTUAL PROPERTY (M)=CURRENT VALUE OF PRODUCT PROFITS (F0)×CONTRIBUTION RATE OF SPECIFIC INTELLECTUAL PROPERTY (L)

The evaluation calculation unit 11 notifies the asset-capitalization-amount calculation unit 13 and management unit 14 of the calculated current value of the intellectual property (M) as the evaluation of the relevant intellectual property.

Subsequently, the asset-capitalization-amount calculation unit 13 takes the relevant intellectual property as a target of capitalization in the event that the evaluation notified is a predetermined amount or more (200,000 yen, for example) necessary for asset capitalization (YES in Step S8). Subsequently, the asset-capitalization-amount calculation unit 13 calculates the total amount of the evaluations of the intellectual properties to be capitalized (Step S9).

Subsequently, the authorization-fee calculation unit 12 calculates an authorization fee regarding the relevant intellectual property (Step S10). An authorization fee includes a fee necessary in the future for authorization of an intellectual property (application filing fee, etc.), and a fee necessary in the future for maintenance of a right (patent fee, etc.). Description will be made later regarding the details of the calculation processing of this authorization fee. The authorization-fee calculation unit 12 notifies the management unit 14 of the calculated authorization fee.

Subsequently, the management unit 14 determines whether or not the procedures of the relevant event are necessary based on the evaluation and authorization fee of the relevant intellectual property notified respectively (Step S11). Here, the management unit 14 determines whether or not all of the claims having possibility of right-to-implementation are deleted by amendment of the scope a right based on the intellectual property information input, and the possibility of right-to-implementation for each claim of the relevant intellectual property (evaluation parameter data in FIG. 4B) at the time of amendment. As a result of this determination, in the event that all of the claims are deleted, the evaluation of the relevant intellectual property is set to zero.

Next, the management unit 14 determines that the procedures are necessary in the event of satisfying Expression (3), and on the other hand, determines that the procedures are not necessary in the event of satisfying Expression (4).
EVALUATION OF INTELLECTUAL PROPERTY>AUTHORIZATION FEE (3)
AUTHORIZATION FEE≧EVALUATION OF INTELLECTUAL PROPERTY (4)

Subsequently, the management unit 14 displays or prints out the determined result regarding whether or not the procedures are necessary (Step S12). Here, the management unit 14 prompts the operator to continuously perform the procedures in the event that Expression (3) is satisfied, and on the other hand, prompts the operator to cancel the procedures in the event that Expression (4) is satisfied. Also, in the event that the technical remaining life F2 is zero, the management unit 14 displays or prints out the effect thereof, and prompts the operator to cancel the procedures.

The intellectual property manager determines how to handle the relevant event based on this determined result. For example, in the event that the evaluation of the intellectual property is greater than the authorization fee at the time of an application being filed, the application is filed by succeeding the right of which the application is filed from an inventor, and on the other hand, in the event that the evaluation of the intellectual property is equal to or less than the authorization fee, the right of which the application is filed is not succeeded from the inventor. Thus, an application can be filed effectively based on the economic value of an intellectual property.

Also, the evaluation calculation unit 11 determines that a shorter duration of either the technical remaining life or right duration of the intellectual property is taken as the service life of the relevant intellectual property, and depreciates the evaluation of the relevant intellectual property in accordance with a predetermined depreciation rule (the equal installment method, constant percentage method, or the like, for example) based on the service life of the authorized intellectual property. In the event that the evaluation of the intellectual property depreciated is less than the relevant authorization fee, the management unit 14 displays or prints out a message prompting the intellectual property manager to stop payment necessary for maintaining the right of the relevant intellectual property. The intellectual property manager can determine regarding whether or not the right should be maintained based on this message, thereby realizing effectiveness of right maintenance costs, such as pensions or the like.

As described above, according to the present embodiment, intellectual properties can be managed based on the economic value of an intellectual property of which the application is scheduled to be filed or has been filed. Further, determination is made objectively regarding whether or not the procedures according to an intellectual property are necessary based on the economic value of the relevant intellectual property, thereby improving workability of determining processing suitable for the event of the procedures according to the intellectual property.

Also, asset capitalization is calculated, whereby intellectual property accounting can be handled.

Also, in the event that all of the claims having possibility of right-to-implementation in the scope of an intellectual property right are deleted by amendment, the evaluation of the relevant intellectual property is set to zero, so variance of the economic value of the intellectual property based on amendment is reflected on the evaluation of the relevant intellectual property accurately.

Also, in the event that a claim having possibility of right-to-implementation in the scope of an intellectual property right is amended, a message prompting reevaluation of the reevaluation items regarding the claim to be amended is output, so the economic value of the intellectual property, which is varied by amendment, is appropriately evaluated, whereby the evaluated result can be reflected on the evaluation of the relevant intellectual property accurately.

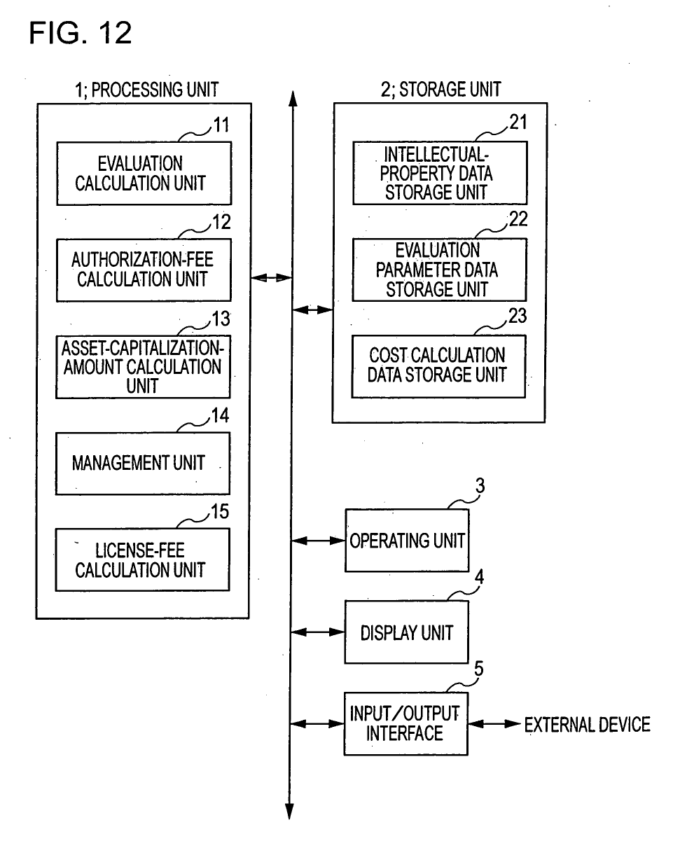

An arrangement may be made, as illustrated in FIG. 12, wherein an implementing-fee calculation unit 15 for calculating a fee such as research and development expense or the like necessary in the future for implementing an intellectual property (this fee is referred to as an implementing-fee) is provided in the processing unit 1, and the management unit 14 determines whether or not the procedures according to the intellectual property right are necessary based on the implementing-fee. For example, an arrangement may be made wherein an implementing-fee is added to an authorization fee, and the result is compared with the evaluation of an intellectual property. Thus, the cost effectiveness of research and development can be quickly accurately understood.

Also, the management unit 14 may determine regarding whether the type of an application is set to a patent or utility model based on the evaluation of the relevant intellectual property at the time of succession or application of the intellectual property. Thus, an application with an appropriate type can be filed based on the economic value of the intellectual property.

Also, an arrangement may be made wherein the asset-capitalization-amount calculation unit 13 calculates the evaluation of an intellectual property from the time of registration of the intellectual property, and the management unit 14 capitalizes this evaluation as fixed assets.

Note that with the above embodiment, the event information and evaluation parameter data may be input from the operating unit 3, or may be input from an external computer or input terminal using the input/output interface via a communication line. With the present embodiment, the operating unit 3 and input/output interface 5 correspond to event input means and evaluation parameter input means.

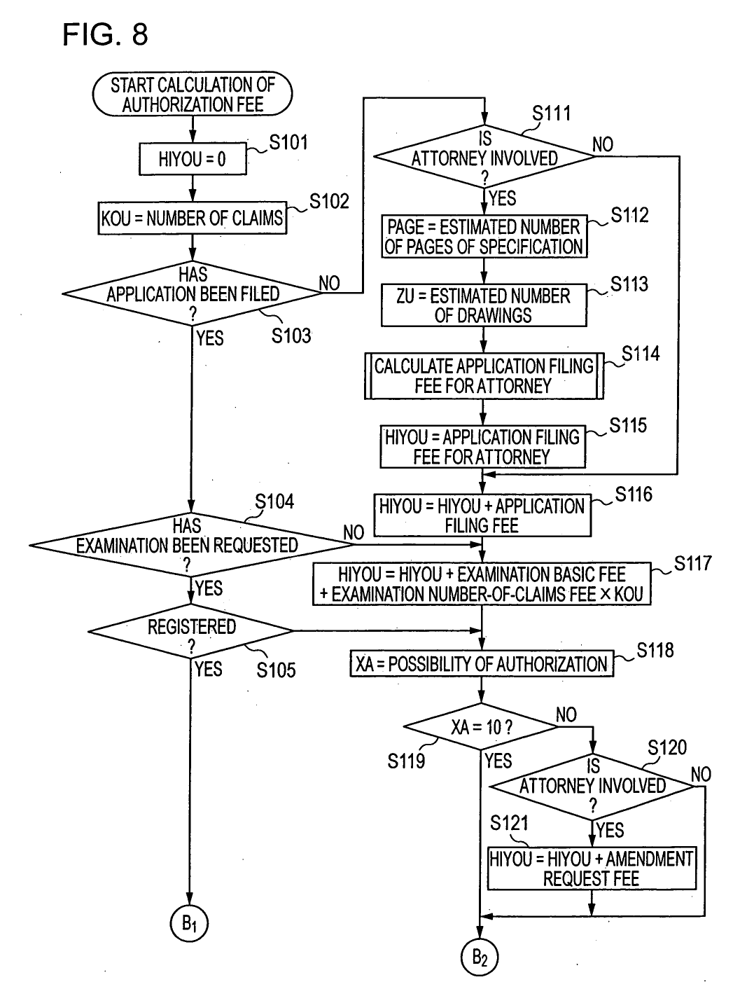

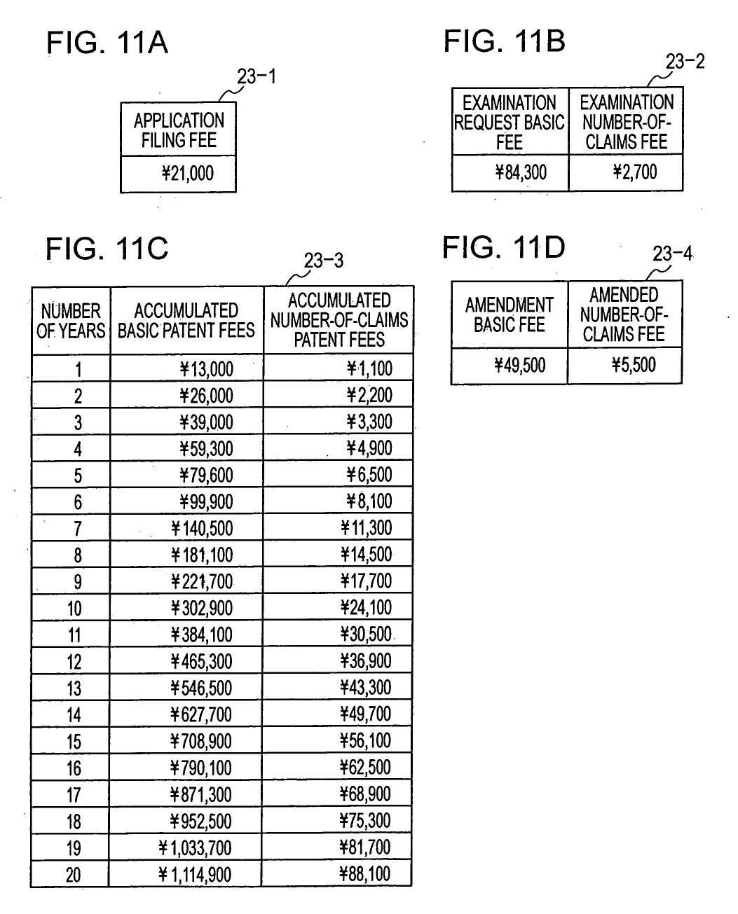

Next, description will be made regarding operation of the authorization-fee calculation unit 12 calculating an authorization fee with reference to FIG. 8 through FIG. 11D. FIG. 8 through FIG. 10 are flowcharts illustrating the flow of authorization-fee calculation processing performed by the authorization-fee calculation unit 12. FIG. 11A through FIG. 11D are diagrams illustrating a configuration example of cost calculation data to be stored in the cost calculation data storage unit 23. The cost calculation data includes various types of data to be used for calculating an authorization fee, but FIG. 11A through FIG. 11D illustrate various types of predetermined fee paid to the Patent Office and a patent fee, of cost calculation data. In addition to these, the cost calculation data includes data of various types of predetermined fee paid to an attorney, for example. Examples of this include a application basic fee, application number-of-claims fee, application number-of-page fee, and application number-of-drawing fee, which are paid at the time of filing an application, an amendment fee paid at the time of amendment, a registration contingent basic fee and registration contingent number-of-claims fee paid at the time of registration, and a written-answer creation fee and written-answer contingent fee, which are paid at the time of being presented with an objection.

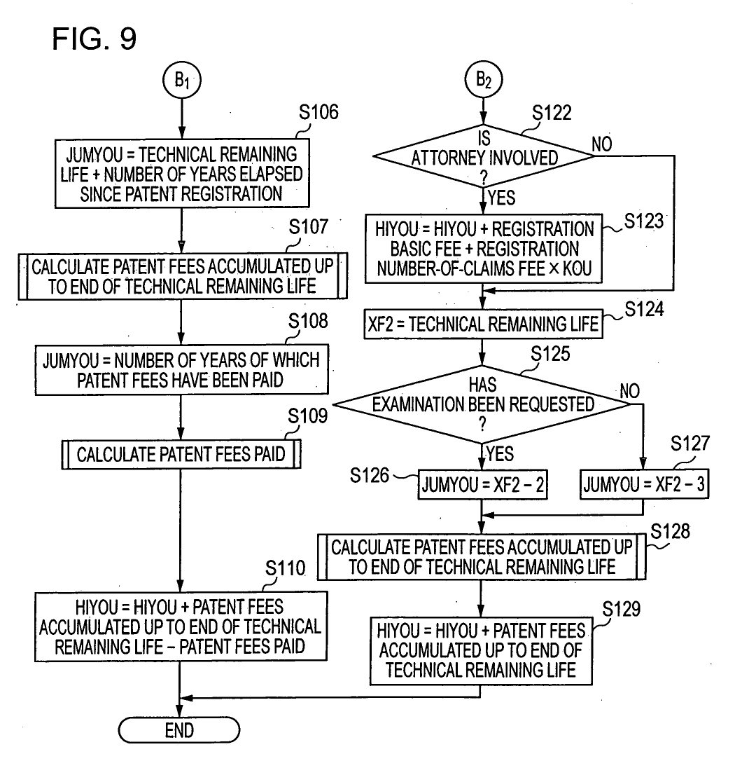

First, description will be made regarding operation for calculating an authorization fee in cases other than being presented with an objection with reference to FIG. 8 and FIG. 9. In FIG. 8, a variable “HIYOU” for an authorization fee is set to zero serving as an initial value, and a variable “KOU” is set to the number of claims of the relevant intellectual property (Steps S101 and S102). Subsequently, determination is made regarding which point on the procedures the relevant event belongs to (Steps S103 through S105). As a result of this determination, the flow proceeds to Step S104 in the case of an event following an application being filed, the flow further proceeds to Step S105 in the case of an event following a request for examination, and further, the flow proceeds to Step S106 in FIG. 9 in the case of an event following registration. On the other hand, the flow proceeds to Step S111 in the case of an event when an application has not been filed, the flow proceeds to Step S117 in the case of an event following an application being filed and also when an examination has not been requested, or the flow proceeds to Step S118 in the case of an event following a request for examination and also when an registration has not been performed.

In Step S106, a variable “JUMYOU” is set to a value obtained by adding the technical remaining life F2 of the relevant intellectual property and the number of elapsed years from the time registration of a patent. Next, patent fees accumulated up to the end of the technical remaining life are calculated using Expression (5) (Step S107).

$$PATENT FEES ACCUMULATED UP TO END OF TECHNICAL REMAINING LIFE = ACCUMULATED BASIC PATENT FEES FOR WORTH OF NUMBER OF “ JUMYOU ” YEARS + ACCUMULATED NUMBER \text{-} OF \text{-} CLAIM PATENT FEES FOR WORTH OF NUMBER OF “ JUMYOU ” YEARS \times “ KOU ” \qquad ( 5 )$$

Next, the variable “JUMYOU” is set to the number of years of which the patent fees have been paid, and paid patent fees are calculated using the above Expression (5) (Steps S108 and S109). Subsequently, patent fees accumulated up to the end of the technical remaining life are added to the variable “HIYOU”, and subtracts the paid patent fees from the variable “HIYOU”, and the value of the variable “HIYOU” of this calculated result is output as an authorization fee (Step S110).

On the other hand, in Step S111 in FIG. 8, involvement/noninvolvement of an attorney regarding the relevant intellectual property is determined, and the flow proceeds to Step S112 in the event of involvement of an attorney, and on the other hand, the flow proceeds to Step S116 in the event of noninvolvement of an attorney.

A variable “PAGE” is set to the number of specification pages (anticipation) in Step S112, and a variable “ZU” is set to the number of drawings (anticipation) in Step S113. Subsequently, an application filing fee to be paid to an attorney is calculated using Expression (6) (Step S114).

$$APPLICATION FILING FEE AS TO ATTORNEY = APPLICATION BASIC FEE + APPLICATION NUMBER \text{-} OF \text{-} CLAIMS FEE \times “ KOU ” + APPLICATION NUMBER \text{-} OF \text{-} PAGE FEE \times “ PAGE ” + APPLICATION NUMBER \text{-} OF \text{-} DRAWING FEE \times “ ZU ” \qquad ( 6 )$$

Subsequently, the variable “HIYOU” is set to the calculated application filing fee as to an attorney (Step S115).

In Step S116, an application filing fee to be paid to the Patent Office is added to the variable “HIYOU”.

In Step S117, a value obtained by multiplying an examination request basic fee and examination number-of-claims fee, which are paid to the Patent Office, by the variable “KOU” is added to the variable “HIYOU”.

In Step S118, a variable “XA” is set to the value of the evaluation parameter A of the possibility of authorization of the relevant intellectual property. Subsequently, the flow proceeds to Step S112 in FIG. 9 in the event that the variable “XA” is 10, and on the other hand, the flow proceeds to Step S112 in the event that the variable “XA” is not 10 (Step S119). Here, the possibility of authorization of the relevant intellectual property is not sufficient in the event that the variable “XA” is not 10, so a fee is calculated in light of amendment in the future. As this calculation processing, involvement/noninvolvement of an attorney is determined in Step S120, and an amendment fee as to the attorney is added to the variable “HIYOU” in the event of involvement of the attorney (Step S121).

In Step S122, involvement/noninvolvement of an attorney is determined, and a value obtained by multiplying a registration contingent basic fee and registration contingent number-of-claims fee, which are paid to the attorney, by the variable “KOU” is added to the variable “HIYOU” in the event of involvement of the attorney (Step S123).

In Step S124, a variable “XF2” is set to the value of the evaluation parameter F2 of the technical remaining life of the relevant intellectual property. Subsequently, 2 is subtracted from the variable “XF2” in the event that a request for examination has been made, and on the other hand, 3 is subtracted from the variable “XF2” in the event that a request for examination has not been made (Steps S125 through S127). Here, the value subtracted from the variable “HIYOU” is the estimated value of a duration necessary until registration (in increments of year).

Subsequently, patent fees accumulated up to the end of the technical remaining life are calculated using the above Expression (5) in Step S128, the patent fees accumulated up to the end of the technical remaining life are added to the variable “HIYOU” in Step S129, and the value of the variable “XF2” serving as this calculated result is output as an authorization fee.

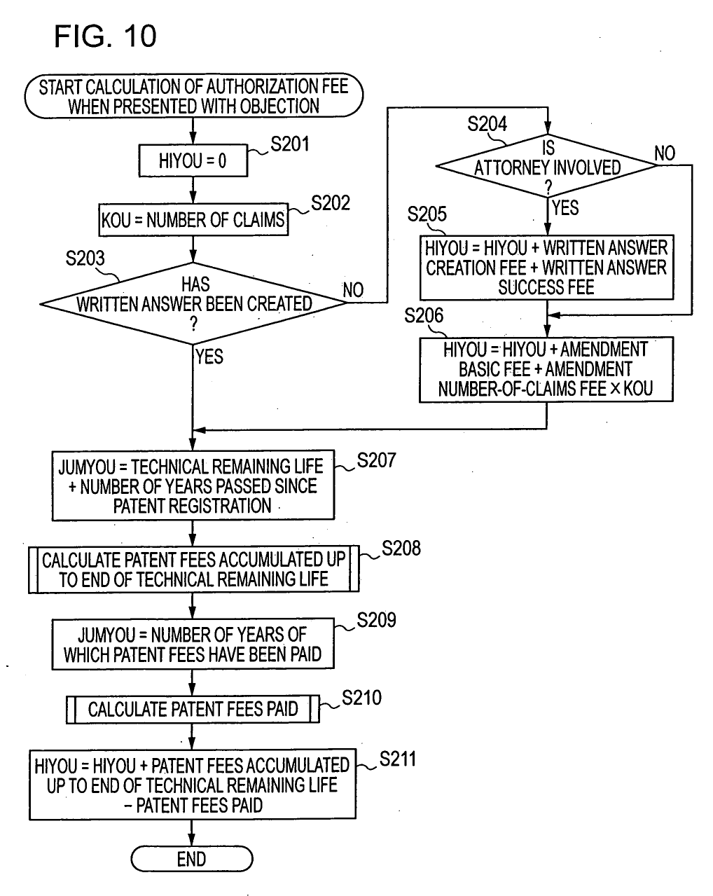

Next, description will be made regarding operation for calculating an authorization fee when presented with an objection with reference to FIG. 10. In FIG. 10, the variable “HIYOU” for an authorization fee is set to zero which is the initial value, and the variable “KOU” is set to the number of claims of the relevant intellectual property (Steps S201 and S202). Subsequently, the flow proceeds to Step S207 in the event that a written answer has been created, and on the other hand, the flow proceeds to Step S204 in the event that a written answer has not been created.

Involvement/noninvolvement of an attorney is determined in Step S204, and a written-answer creation fee and written-answer contingent fee as to the attorney are added to the variable “HIYOU” in the event of involvement of the attorney in Step S205, and on the other hand, the flow proceeds to Step S206 in the event of noninvolvement of the attorney. Subsequently, in Step S206, a value obtained by multiplying an amendment basic fee and amendment number-of-claims fee, which are paid to the Patent Office, by the variable “KOU” is added to the variable “HIYOU”.

In Steps S207 through S211, the calculation processing of an authorization fee (variable “HIYOU”) is performed in the same way as Steps S106 through S110 in above FIG. 9, and this calculated result is output.

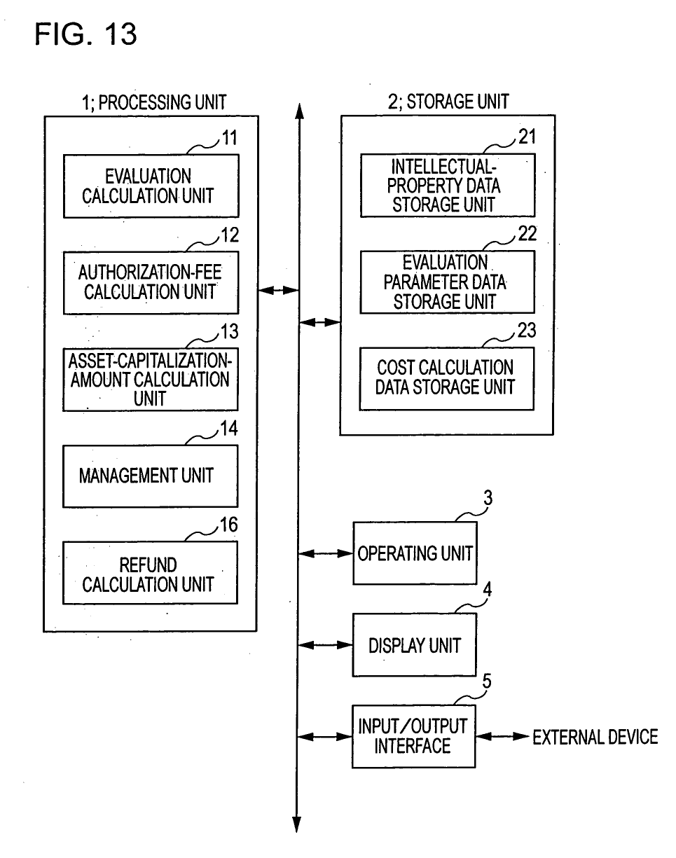

Note that with the above embodiment, as illustrated in FIG. 13, the processing unit 1 may include a refund calculation unit 16 for calculating a refund as to the inventor of an intellectual property. Two calculation methods for obtaining a refund are shown below.

A first calculation method of a refund:

Let us say that a refund is paid as to an annual profit estimated amount every year, and the annual profit estimated amount (F1) is reevaluated at the time of calculating a refund. A refund (O) is calculated using the following expression.

$$REFUND ( O ) = ANNUAL PROFIT ESTIMATED AMOUNT ( F 1 ) \times CONTRIBUTION RATE OF RELEVANT INTELLECTUAL PROPERTY ( L ) \times RETURN RATE ( N )$$

A second calculation method of a refund:

The refund (O) is calculated according to the current value of an intellectual property (M) using the following expression.

$$REFUND ( O ) = CURRENT VALUE OF INTELLECTUAL PROPERTY ( M ) \times CONTRIBUTION RATE OF RELEVANT INTELLECTUAL PROPERTY ( L ) \times RETURN RATE ( N )$$

Note that, with both the first and second methods, the return rate (N) represents the percentage of profits returned to an inventor, and a predetermined constant (1%, for example) is employed as this rate.

According to the second calculation method, an amount identical with the value possessed by the relevant intellectual property can be returned to the inventor in bulk by calculating the refund based on the current value of the intellectual property (M).

Now, an arrangement may be made wherein a program for realizing the functions of the processing unit in FIG. 1 is recorded in a computer-readable recording medium, and the program recorded in this recording medium is read in a computer system, and executed, thereby performing intellectual property management processing. Note that the term “computer system” mentioned here may include an operating system and hardware such as peripheral equipment and so forth.

Also, the “computer system” is to include a Web site providing environment (or display environment) in the event of utilizing a WWW system.

Also, the term “computer-readable recording medium” means a portable medium such as a flexible disk, magnetic optical disk, ROM, CD-ROM, and the like, a storage device such as a hard disk built into the computer system, and the like.

Further, the “computer-readable recording medium” is to include, such as volatile memory (RAM) within the computer system serving as a server or client in the event that a program is transmitted via a network such as the Internet or the like, or a communication line such as a phone line or the like, a medium storing the program for a certain period.

Also, the above program may be transmitted to another computer system from the computer system storing this program in a storage device or the like via a transmission medium, or transmitted wave within the transmission medium. Here, the “transmission medium”, which transmits a program, means a medium having a function for transmitting information, such as a network (communication network) like the Internet or the like, or a communication line (communication cable) like a phone line or the like.

Also, the above program may be a program for realizing a part of the above functions. Further, the above program may be a so-called difference file (difference program) for realizing the above functions by a combination with a program already recorded in the computer system.

Thus, the embodiment of the present invention has been described with reference to the drawings, but the specific configuration is not restricted to this embodiment, and design modifications and the like without departing from the spirit and scope of the present invention are encompassed in the present invention.

1. An intellectual-property management device for managing an intellectual property of which an application is scheduled to be filed or has been filed, said management device comprising:
an intellectual-property data storage unit for storing management data regarding said intellectual property for said intellectual property;
an evaluation parameter storage unit for storing evaluation parameter data for said intellectual property;
a cost-calculation data storage unit for storing predetermined cost data to be used for calculating costs necessary for authorizing and maintaining a right of said intellectual property;
event input means for inputting the event information of procedures according to an intellectual property right;
evaluation parameter input means for inputting evaluation parameter data of said intellectual property;
evaluation calculation unit for calculating the evaluation of said intellectual property based on said management data and said evaluation parameter data;
a patent-fee calculation unit for calculating patent fees necessary in the future for authorizing and maintaining the right of said intellectual property based on said management data and said cost data; and
a management unit for, in response to said event information input, comparing said calculated evaluation with the patent fees when an event occurs, and managing said intellectual property based on this compared result.

2. An intellectual-property management device according to claim 1, wherein said patent-fee calculation unit calculates a total fee necessary in the future for authorizing and maintaining the right of said intellectual property.

3. An intellectual-property management device according to claim 1, further comprising an implementing-fee calculation unit for calculating an implementing-fee necessary in the future for implementing said intellectual property,
wherein said management unit adds said implementing-fee to said patent fees, compares the result with said evaluation, and manages said intellectual property based on this compared result.

4. An intellectual-property management device according to claim 1, further comprising a refund calculation unit for calculating a refund as to an inventor of the intellectual property based on said evaluation.

5. An intellectual-property management device according to claim 1, further comprising an asset-capitalization-amount calculation unit for targeting at said intellectual property of which said evaluation is a predetermined amount or more for asset capitalization, and calculating a total amount of the evaluation of said intellectual property to be capitalized.

6. An intellectual-property management device according to claim 5, wherein said asset-capitalization-amount calculation unit includes a function for determining whether or not said intellectual property is authorized based on said management data, and restricts said intellectual property to be capitalized to an authorized intellectual property.

7. An intellectual-property management device according to claim 1, wherein said management unit determines whether or not procedures according to the intellectual property are necessary based on said compared result.

8. An intellectual-property management device according to claim 7, wherein said evaluation calculation unit for determining that a shorter duration of either a technical remaining life or a right duration of said intellectual property is taken as a service life of the intellectual property, and depreciating the evaluation of the intellectual property in accordance with a predetermined depreciation rule based on the service life of the authorized intellectual property;
and wherein said management unit outputs a message prompting stopping of payment of expenses necessary for maintaining the right of said intellectual property in the event that the evaluation of the intellectual property depreciated is less than said patent fees.

9. An intellectual-property management device according to claim 7, wherein said management unit determines whether or not the application of said intellectual property is necessary based on the evaluation of the intellectual property when the succession or application of the intellectual property is filed.

10. An intellectual-property management device according to claim 7, wherein said management unit determines the type of application based on the evaluation of said intellectual property when succession or application of the intellectual property is filed.

11. An intellectual-property management device according to claim 1, wherein said evaluation parameter data includes parameter data regarding possibility of right-to-implementation for each claim of said intellectual property,
and wherein said management unit sets the evaluation of said intellectual property to zero in the event that all of the claims having possibility of right-to-implementation are deleted by amendment of a right generic claim of the intellectual property using said event information.

12. An intellectual-property management device according to claim 11, wherein said management unit outputs a message prompting reevaluation of the evaluation items regarding the claims to be amended in the event that the claims having possibility of right-to-implementation of the right generic claim of said intellectual property are amended using said event information.

13. An intellectual-property management device for managing an intellectual property of which an application is scheduled to be filed or has been filed, calculating evaluation of said intellectual property from a time the intellectual property was registered, and capitalizing this evaluation as fixed assets.

14. An intellectual-property management program for performing intellectual property management processing in an intellectual-property management device for managing an intellectual property of which an application is scheduled to be filed or has been filed, said program for controlling a computer to execute:
processing for inputting event information of procedures according to an intellectual property right;
processing for inputting an evaluation parameter data of said intellectual property;
evaluation calculation processing for calculating an evaluation of said intellectual property based on the management data and said evaluation parameter data regarding the intellectual property, which is stored in a storage unit;
patent-fee calculation processing for calculating patent fees necessary in the future for authorizing and maintaining the right of said intellectual property based on said management data and predetermined cost data, which is stored in said storage unit, to be used for calculating costs necessary for authorizing and maintaining the right of the intellectual property; and
management processing for, in response to said event information input, comparing said calculated evaluation with the patent fees when an event occurs, and managing said intellectual property based on this compared result.

15. An intellectual-property management program according to claim 14, wherein said patent-fee calculation processing calculates the total amount of costs necessary in the future for authorizing and maintaining the right of said intellectual property.

16. An intellectual-property management program according to claim 14, further controlling the computer to execute implementing-fee calculation processing for calculating an implementing-fee necessary in the future for implementing said intellectual property,
wherein said management processing adds said implementing-fee to said patent fees, compares the result with said evaluation, and manages said intellectual property based on this compared result.

17. An intellectual-property management program according to claim 14, further controlling the computer to execute refund calculation processing for calculating a refund as to an inventor of the intellectual property based on said evaluation.

18. An intellectual-property management program according to claim 14, further controlling the computer to execute asset-capitalization-amount calculation processing for targeting at said intellectual property of which said evaluation is a predetermined amount or more for asset capitalization, and calculate the total amount of the evaluation of said intellectual property to be capitalized.

19. An intellectual-property management program according to claim 18, wherein said asset-capitalization-amount calculation processing for determining whether or not said intellectual property is authorized based on said management data, and restricts said intellectual property to be capitalized to an authorized intellectual property.

20. An intellectual-property management program according to claim 14, wherein said management processing determines whether or not procedures according to an intellectual property right are necessary based on said compared result.

21. An intellectual-property management program according to claim 20, wherein said evaluation calculation processing for determining that a shorter duration of either a technical remaining life or a right duration of said intellectual property is taken as a service life of the intellectual property, and depreciating the evaluation of the intellectual property in accordance with a predetermined depreciation rule based on the service life of an authorized intellectual property,
and wherein said management processing outputs a message prompting stopping of payment of expenses necessary for maintaining the right of said intellectual property in the event that the evaluation of the intellectual property depreciated is less than said patent fees.

22. An intellectual-property management program according to claim 20, wherein said management processing determines whether or not the application of said intellectual property is necessary based on the evaluation of the intellectual property when succession or application of the intellectual property is filed.

23. An intellectual-property management program according to claim 20, wherein said management processing determines the type of application based on the evaluation of said intellectual property when succession or application of the intellectual property is filed.

24. An intellectual-property management program according to claim 14, wherein said evaluation parameter data includes parameter data regarding possibility of right-to-implementation for each claim of said intellectual property,
and wherein said management processing sets the evaluation of said intellectual property to zero in the event that all of the claims having possibility of right-to-implementation are deleted by amendment of a right generic claim of the intellectual property using said event information.

25. An intellectual-property management program according to claim 24, wherein said management processing outputs a message prompting reevaluation of the evaluation items regarding the claims to be amended in the event that the claims having possibility of right-to-implementation of the right generic claim of said intellectual property are amended using said event information.

26. An intellectual-property management program for performing intellectual-property management processing in an intellectual-property management device for managing an intellectual property of which an application is scheduled to be filed or has been filed, said program for controlling a computer to execute:
processing for calculating an evaluation of said intellectual property from a time the intellectual property was registered; and
processing for capitalizing this evaluation as fixed assets.
